(19) United States
(12) Patent Application Publication
(10) Pub. No.: US 2007/0202392 A1
(43) Pub. Date: Aug. 30, 2007

(54) ELECTROCATALYST COMPOSITIONS FOR USE IN AN ELECTROCHEMICAL FUEL CELL AND METHODS OF MAKING THE SAME

(76) Inventors: Guy Faubert, Vancouver, BC (CA); Ping He, Richmond, BC (CA); Scott J. McDermid, Vancouver, BC (CA); Myles L. Bos, Burnaby, BC (CA); Rajeev Vohra, Burnaby, BC (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/682,232

(22) Filed: Mar. 5, 2007

Related U.S. Application Data
(63) Continuation-in-part of application No. 11/611,361, filed on Dec. 15, 2006.
(60) Provisional application No. 60/753,640, filed on Dec. 22, 2005.

(51) Int. Cl. H01M 4/96; H01M 4/94; H01M 4/90; B01J 21/18; B01J 23/60; B01J 23/54

(52) U.S. Cl. 429/44; 502/182; 502/183

(57) ABSTRACT

An electrocatalyst composition for use in an electrochemical fuel cell is disclosed. The electrocatalyst composition comprises (1) an electrocatalyst support comprising a carbon-containing species and at least one hydrogen peroxide and/or oxygen radical decomposition catalyst, and (2) a noble metal electrocatalyst supported on the electrocatalyst support. In addition, the at least one hydrogen peroxide and/or oxygen radical decomposition catalyst comprises transition metal inclusions within the electrocatalyst support, and the electrocatalyst support does not comprise any nitrogen-containing species or metal oxides.

### CROSS-REFERENCE TO RELATED APPLICATION

This application is a continuation-in-part of U.S. patent application Ser. No. 11/611,361 filed Dec. 15, 2006, which application claims the benefit under 35 U.S.C. §119(e) of U.S. Provisional Patent Application No. 60/753,640 filed Dec. 22, 2005, both of which applications are incorporated herein by reference in their entireties.

### BACKGROUND OF THE INVENTION

1. Field of the Invention

The present invention relates generally to electrochemical fuel cell systems, and, more particularly, to an electrocatalyst composition for use in an electrochemical fuel cell which comprises at least one hydrogen peroxide and/or oxygen radical decomposition catalyst.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area.

One type of electrochemical fuel cell is the polymer electrolyte membrane (PEM) fuel cell. PEM fuel cells generally employ a membrane electrode assembly (MEA) comprising a solid polymer electrolyte or ion-exchange membrane disposed between two electrodes. Each electrode typically comprises a porous, electrically conductive substrate, such as carbon fiber paper or carbon cloth, which provides structural support to the membrane and serves as a fluid diffusion layer. The membrane is ion conductive (typically proton conductive), and acts both as a barrier for isolating the reactant streams from each other and as an electrical insulator between the two electrodes. A typical commercial PEM is a sulfonated perfluorocarbon membrane sold by E.I. Du Pont de Nemours and Company under the trade designation Nafion®. The electrocatalyst, disposed between the membrane and the electrodes, is typically a precious metal composition (e.g., platinum metal black or an alloy thereof) and may be provided on a suitable electrocatalyst support (e.g., fine platinum particles supported on a carbon black support). The electrocatalyst and/or electrocatalyst support may also contain ionomer.

In a fuel cell, a MEA is typically interposed between two separator plates that are substantially impermeable to the reactant fluid streams. The plates typically act as current collectors and provide support for the MEA. In addition, the plates may have reactant channels formed therein and act as flow field plates providing access for the reactant fluid streams to the respective porous electrodes and providing for the removal of reaction products formed during operation of the fuel cell.

In a fuel cell stack, a plurality of fuel cells are connected together, typically in series, to increase the overall output power of the assembly. In such an arrangement, one side of a given separator plate may serve as an anode flow field plate for one cell and the other side of the plate may serve as the cathode flow field plate for the adjacent cell. In this arrangement, the plates may be referred to as bipolar plates. Typically, a plurality of inlet ports, supply manifolds, exhaust manifolds and outlet ports are utilized to direct the reactant fluid to the reactant channels in the flow field plates.

A broad range of reactants can be used in PEM fuel cells. For example, the fuel stream may be substantially pure hydrogen gas, a gaseous hydrogen-containing reformats stream, or methanol in a direct methanol fuel cell. The oxidant may be, for example, substantially pure oxygen or a dilute oxygen stream such as air.

During normal operation of a PEM fuel cell, fuel is electrochemically oxidized on the anode side, typically resulting in the generation of protons, electrons, and possibly other species depending on the fuel employed. The protons are conducted from the reaction sites at which they are generated, through the membrane, to electrochemically react with the oxidant on the cathode side. The electrons travel through an external circuit providing useable power and then react with the protons and oxidant on the cathode side to generate water reaction product.

The operation of a PEM fuel cell, comprising a platinum electrocatalyst on the cathode side, results in the production of hydrogen peroxide and oxygen radicals from the partial reduction of oxygen in the oxidant stream. Over time, such hydrogen peroxide and oxygen radicals damage and impair the function of various elements of the MEA, which leads to declining fuel cell efficiency. For example, the peroxide/oxygen radicals may oxidize the membrane, leading to the release of fluoride anions in the case of fluorinated membranes, such as Nafion®. In addition, the peroxide/oxygen radicals, and any released fluoride ions from the membrane, may contribute to the ionization and solubilization of the platinum electrocatalyst, and to the partial or complete oxidation of the carbon electrocatalyst support and electrode fluid diffusion layers. Platinum ions released from such solubilization migrate into various areas of the MEA, including the membrane itself, forming large-sized agglomerates. These agglomerates possess less surface area than the dispersed nanoparticles from which they are formed and, therefore, the formation of such agglomerates causes a loss in fuel cell performance. Released platinum ions may also be lost in the cathode effluent, causing a decrease in performance as well. Partial or complete oxidation of carbon structures in the MEA causes morphological and chemical changes to the MEA that can impact its mass transfer characteristics.

U.S. Pat. No. 6,335,112 and U.S. Patent Application Publication No. 2005/0136308, each of which are herein incorporated by reference in their entirety, disclose the use of various catalysts for the decomposition of hydrogen peroxide and/or oxygen radical species. As disclosed, these decomposition catalysts may be applied to the ion-exchange membrane and/or electrocatalyst layer of a fuel cell as a means of protecting the membrane from any reactive hydrogen peroxide and/or oxygen radical species produced. However, upon application, such a decomposition catalyst may itself lead to a decreased fuel cell performance by, for example, presenting a mass transport barrier or interfering with the function of the fuel cell electrocatalyst.

Accordingly, although there have been advances in the field, there remains a need in the art for further improvements to mitigate or eliminate degradation of MEA structures by hydrogen peroxide and other radicals. The present invention addresses these needs and provides further related advantages.

### BRIEF SUMMARY OF THE INVENTION

In brief, the present invention relates generally to electrochemical fuel cell systems, and, more particularly, to an electrocatalyst composition for use in an electrochemical fuel cell which comprises at least one hydrogen peroxide and/or oxygen radical decomposition catalyst.

In one embodiment, an electrocatalyst composition for use in an electrochemical fuel cell is provided, the electrocatalyst composition comprising: (1) an electrocatalyst support comprising a carbon-containing species and at least one hydrogen peroxide and/or oxygen radical decomposition catalyst; and (2) a noble metal electrocatalyst supported on the electrocatalyst support, wherein the at least one hydrogen peroxide and/or oxygen radical decomposition catalyst comprises transition metal inclusions within the electrocatalyst support, and wherein the electrocatalyst support does not comprise any nitrogen-containing species or metal oxides.

In more specific embodiments, the transition metal of the electrocatalyst support is not a Fenton's catalyst. For example, in more specific embodiments, the transition metal of the electrocatalyst support may be selected from the group consisting of Mn and Zn. In addition, in more specific embodiments, the noble metal electrocatalyst may be platinum.

In another embodiment, a membrane electrode assembly is provided comprising: (1) an anode fluid diffusion layer; (2) a cathode fluid diffusion layer; (3) an ion-exchange membrane interposed between the anode and cathode fluid diffusion layers; (4) an anode electrocatalyst layer interposed between the ion-exchange membrane and the anode fluid diffusion layer; and (5) a cathode electrocatalyst layer interposed between the ion-exchange membrane and the fluid diffusion layer, wherein at least one of the anode and cathode electrocatalyst layers comprises the above described electrocatalyst composition.

In yet another embodiment, an electrochemical fuel cell comprising the above described membrane electrode assembly is provided.

In yet another embodiment, a method of making an electrocatalyst composition for use in an electrochemical fuel cell is provided, the method comprising: (1) pyrolyzing a carbon-containing species and a transition metal-containing species in the absence of any nitrogen-containing species to produce an electrocatalyst support which does not comprise any nitrogen-containing species or metal oxides; and (2) depositing a noble metal electrocatalyst on the electrocatalyst support.

In more specific embodiments, the transition-metal containing species may be selected from the group consisting of Mn and Zn, and salts, oxides and organometallic complexes thereof. In addition, in more specific embodiments, the noble metal electrocatalyst may be platinum.

These and other aspects of the invention will be evident upon reference to the following detailed description and attached drawings.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a graph illustrating the effect of Al(III), Mn(II) and MnO₂ on the degradation rate of the ion-exchange membrane.

FIG. 2 is a graph illustrating the rate of ion-exchange membrane degradation as a function of the loading of MnO₂ on the ion-exchange membrane.

FIG. 3 is a graph illustrating performance loss of a fuel cell as a function of the loading of MnO₂ on the ion-exchange membrane.

FIG. 4 is a graph illustrating the performance loss of a fuel cell as a function of the location of MnO₂ or Mn(II).

FIG. 5 shows the polarization curves of two fuel cells, one with an Mn-containing carbon support material in the cathode electrocatalyst layer and one without an Mn-containing carbon support material in the cathode electrocatalyst layer.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As noted above, in U.S. Pat. No. 6,335,112 and U.S. Patent Application Publication No. 2005/0136308, the use of various hydrogen peroxide and/or oxygen radical decomposition catalysts, applied to the ion-exchange membrane and/or electrocatalyst layer of a fuel cell, was disclosed as a means of protecting the membrane from reactive hydrogen peroxide and/or oxygen radical species produced during operation of the fuel cell. However, as noted above and further discussed below, such an applied decomposition catalyst may itself lead to a decreased fuel cell performance by, for example, presenting a mass transport barrier or interfering with the function of the fuel cell electrocatalyst.

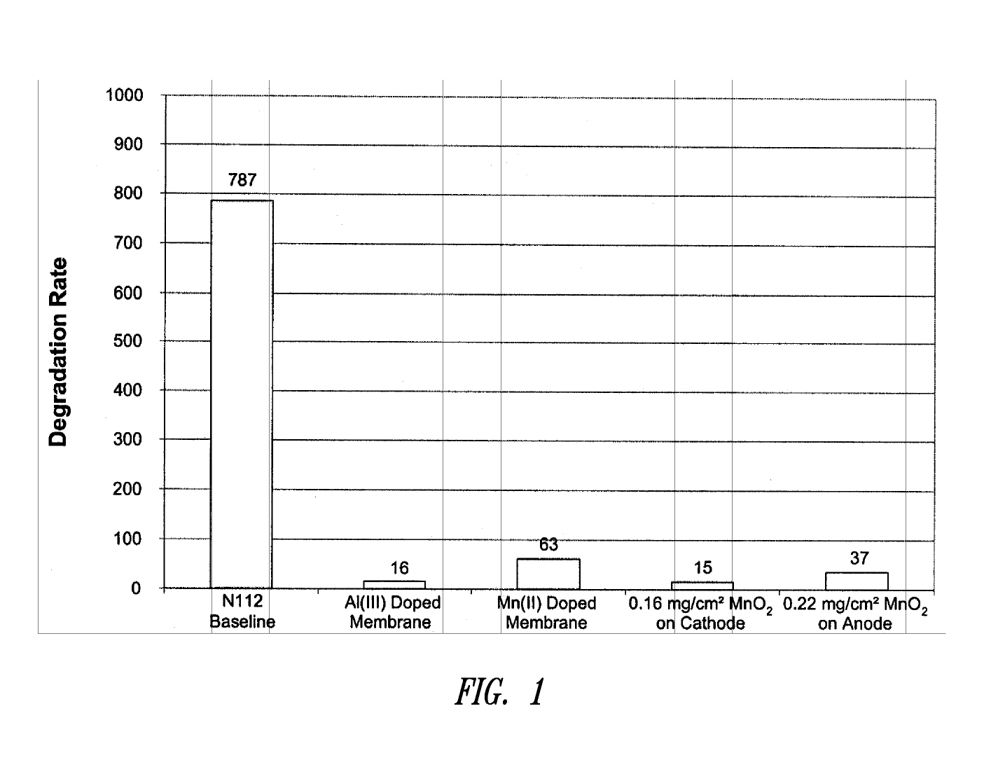

FIG. 1 shows the degradation rate of Nafion® 112 during operation in a PEM fuel cell. The degradation rate was determined by measuring the cumulative oxidant outlet conductivity (μS) of the effluent at open circuit voltage and dividing by the time (hours) of operation. The greater the conductivity of the oxidant effluent indicates that more HF was formed and hence more membrane degradation occurred. For Nafion® 112, the degradation rate was determined to be 787 μS/hour. Even for a perfluorinated membrane, significant membrane degradation was thus observed. A significant reduction in membrane degradation was observed when the membrane was doped with either Al(III) or Mn(II). For the Al(III) doped membrane, the degradation rate was reduced to 16 μS/hour and for the Mn(II) doped membrane, the degradation rate was 63 μS/hour. In other trials, a separate layer comprising MnO₂ was coated on either the cathode or anode electrodes prior to bonding to the membrane to form an MEA. When a 0.16 mg/cm² MnO₂ layer was coated on the cathode electrode prior to bonding with the membrane, the subsequent membrane degradation rate was only 15 μS/hour. Similarly, when a 0.22 mg/cm² MnO₂ layer was coated on the anode electrode prior to bonding with the membrane, the subsequent membrane degradation rate was only 37 μS/hour.

To summarize, FIG. 1 illustrates that Nafion® 112 undergoes significant membrane degradation under the operational conditions found in a PEM fuel cell and that Al(III), Mn(II) and MnO₂ significantly reduces such degradation.

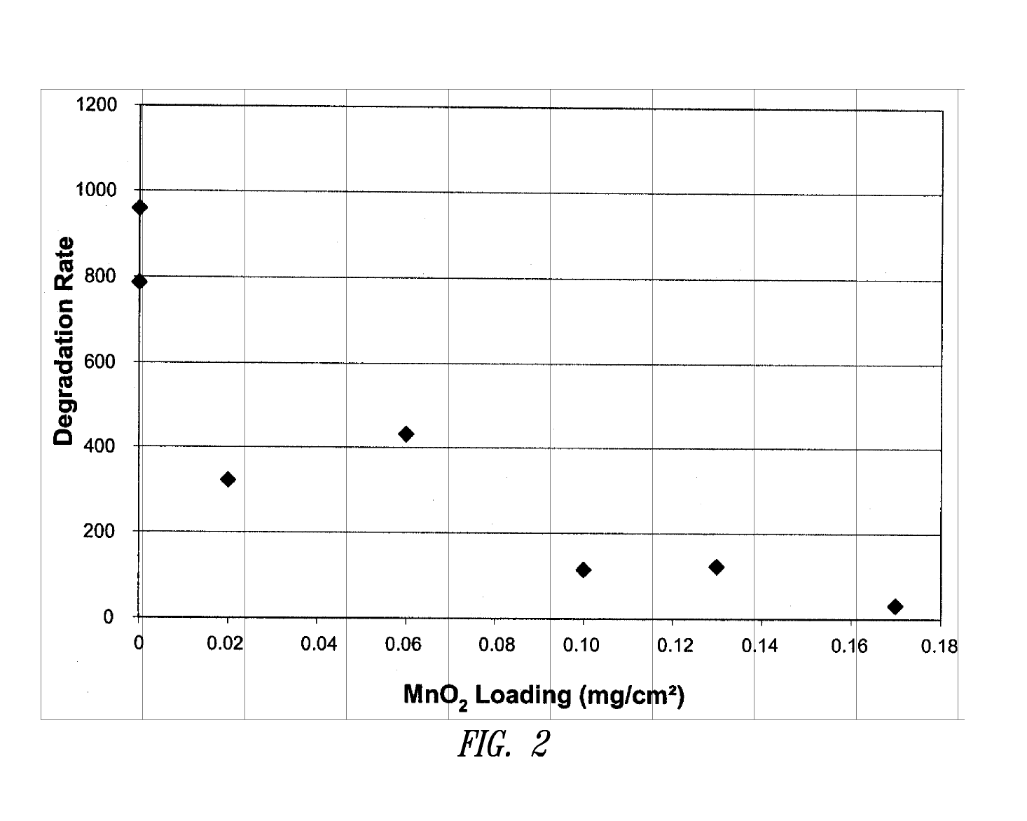

In FIG. 2, the loading of MnO₂ as a separate layer coated on the cathode electrode prior to bonding with a Nafion® 112 membrane was varied from 0 mg/cm² to 0.17 mg/cm² and the subsequent degradation rate in μS/hour was then determined as discussed above in reference to FIG. 1. Even with a loading as small as 0.02 mg/cm², the rate of membrane degradation was significantly reduced as compared to baseline Nafion® 112 where no MnO₂ was used. A trend was clearly observed such that the rate at which the membrane degrades decreases with increasing loadings of MnO₂ on the membrane.

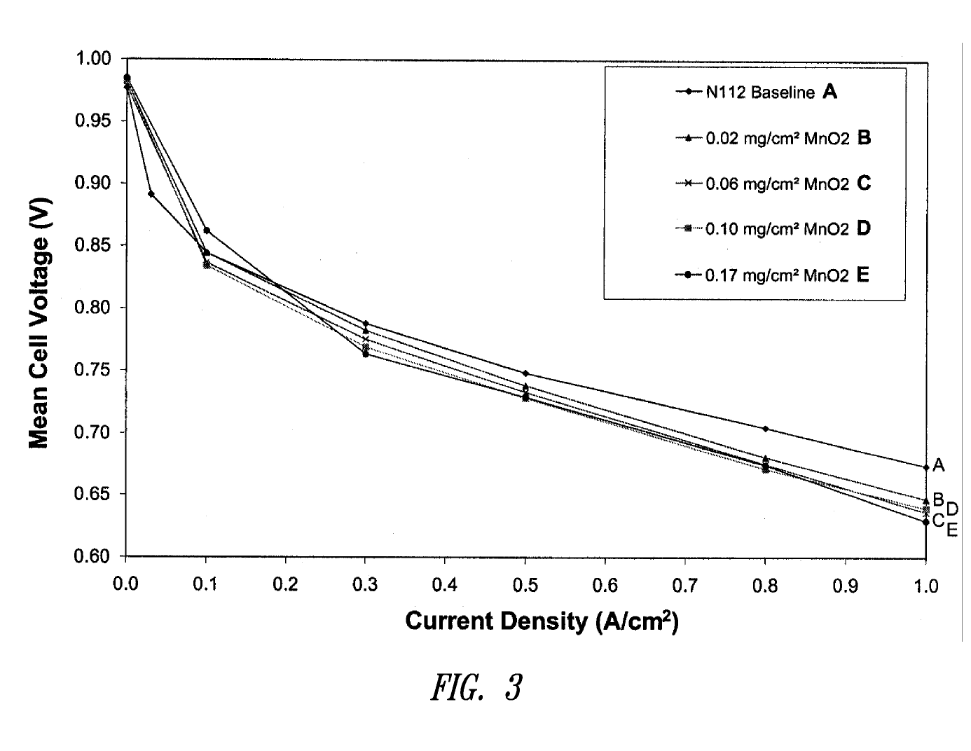

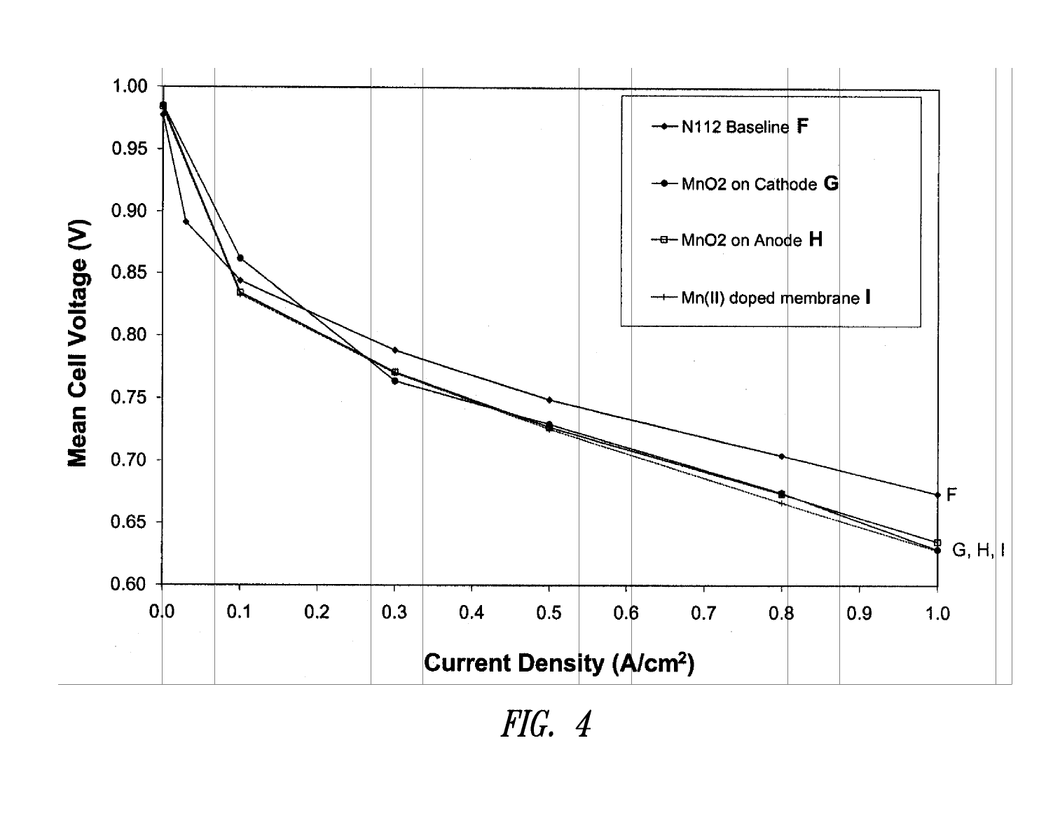

However, as shown in FIGS. 3 and 4, the performance of the fuel cell suffers in the presence of MnO₂ and Mn(II). FIG. 3 illustrates the fuel cell performance of a 5-cell stack. Example A was the baseline measurement with no MnO₂ present in the MEA. Examples B through E had MnO₂ loadings of 0.02, 0.06, 0.10 and 0.17 mg/cm², respectively, on the cathode. Nafion® 112 was used as the membrane in all examples. Air stoichiometry was maintained at 1.8 and fuel stoichiometry was 1.5; temperature at the inlet was 70° C. The best performance was observed for the baseline MEA where no MnO₂ was present. Even for example B with only a 0.02 mg/cm² loading of MnO₂, a significant drop in performance was measured by mean cell voltage at a current density of 1.0 A/cm². Further, the results show that the performance drop increases as the loading increases from 0.02 to 0.17 mg/cm². In FIG. 4, a similar 5-cell stack was operated under similar conditions as those under FIG. 3. Example F is the baseline MEA where no MnO₂ was present. For example G, a 0.17 mg/cm² loading of MnO₂ was coated on the cathode electrode prior to bonding with a Nafion® 112 membrane. For example H, a 0.22 mg/cm² loading of MnO₂ was coated on the anode electrode prior to bonding with a Nafion® 112 membrane. For example I, a Nafion® 112 membrane was doped with Mn(II) prior to bonding with conventional electrodes to form the MEA. As shown in FIG. 3, in all cases, the incorporation of Mn in the MEA resulted in a significant decrease in performance was observed.

The present invention provides an alternative to the foregoing approach and relates to incorporating hydrogen peroxide and/or oxygen radical decomposition catalysts within the carbon structure of the electrocatalyst support of an electrocatalyst layer in an electrochemical fuel cell. This differs from depositing, or supporting, such catalysts on the electrocatalyst support, which, as discussed above, is known in the prior art. Without being bound by theory, it is believed that incorporating the decomposition catalysts within the structure of the electrocatalyst support, in close proximity to where the hydrogen peroxide and oxygen radicals are generated, will minimize the effect of any hydrogen peroxide and oxygen radicals produced at the electrocatalyst. It is also believed that incorporating the decomposition catalysts within the structure of the electrocatalyst support will hinder or prevent such decomposition catalysts from being washed away by the reactant effluents during operation. In addition, it is also believed that incorporating the decomposition catalysts within the structure of the electrocatalyst support will enable such catalysts to be present in smaller quantities than in assemblies wherein the catalyst is supported on the electrocatalyst support, thereby having less of an impact on mass transport and the performance of the fuel cell electrocatalyst.

In one embodiment, an electrocatalyst composition for use in an electrochemical fuel cell is provided, the electrocatalyst composition comprising: (1) an electrocatalyst support comprising a carbon-containing species and at least one hydrogen peroxide and/or oxygen radical decomposition catalyst; and (2) a noble metal electrocatalyst supported on the electrocatalyst support, wherein the at least one hydrogen peroxide and/or oxygen radical decomposition catalyst comprises transition metal inclusions within the electrocatalyst support, and wherein the electrocatalyst support does not comprise any nitrogen-containing species or metal oxides.

Representative examples of the carbon-containing species of the electrocatalyst support include carbon blacks (such as acetylene black, Vulcan®, Ketjen® black), carbon fibers, and graphites.

Representative examples of the transition metal of the electrocatalyst support include transition metals which are not Fenton's catalysts. As used herein, “Fenton's catalyst” refers to a transition metal ion or complex, such as Fe²⁺ and Fe³⁺, that reacts with hydrogen peroxide to generate hydroxyl radicals (OH⁻), perhydroxyl radicals (OOH⁻), and other oxidative radical species that can oxidize a wide range of organic compounds. For example, representative transition metals which are not Fenton's catalysts include Mn and Zn.

Representative examples of the noble metal electrocatalyst include platinum, palladium, ruthenium, and alloys thereof.

When used in an electrochemical fuel cell, the electrocatalyst composition may be employed as the anode electrocatalyst layer and/or the cathode electrocatalyst layer, or may be incorporated into an anode electrocatalyst layer and/or a cathode electrocatalyst layer that also comprises other components. As one of ordinary skill in the art will appreciate, such anode and cathode electrocatalyst layers are interposed between the ion-exchange membrane and the anode and cathode fluid diffusion layers, respectively, of the membrane electrode assembly of the fuel cell. Furthermore, as one of ordinary skill in the art will appreciate, such anode and cathode electrocatalyst layers may be supported on the anode and cathode fluid diffusion layers, or may be supported on the ion-exchange membrane directly (thereby forming a catalyst-coated membrane).

As noted, the disclosed electrocatalyst support does not comprise any nitrogen-containing species, such as nitrides, or any metal oxides, such as MnO₂. Without being bound by theory, it is believed that under the reducing conditions at which the disclosed electrocatalyst support is prepared, the inclusion of metal oxides into the electrocatalyst support will not be observed. By way of background, the use of electrocatalyst compositions comprising, within the carbon structure, both (1) transition metals, and (2) nitrogen-containing species and/or metal oxides have been previously investigated (see, e.g., U.S. Patent Application Publication No. 2005/0112451; U.S. Patent Application Publication No. 2004/0010160; He et al., J. New Mat. Electrochem. Systems 2, 243-251 (1999); and Faubert et al., Electrochimica Acta 44, 2589-2603 (1999)). Without being bound by theory, it is believed that adding nitrogen-containing species to the electrocatalyst support adds unnecessary cost to the preparation procedure.

In another embodiment, a method of making the electrocatalyst composition described above is provided. The method comprises: (1) pyrolyzing a carbon-containing species and a transition metal-containing species in the absence of any nitrogen-containing species to produce an electrocatalyst support which does not comprise any nitrogen-containing species or metal oxides; and (2) depositing a noble metal electrocatalyst on the electrocatalyst support.

Representative examples of the carbon-containing species include any hydrocarbon molecule, such as 3,4,9,10-perylenetetracarboxylic dianhydride or simpler molecules such as methane.

Representative examples of the transition-metal containing species include Mn and Zn, and salts, oxides and organometallic complexes thereof. In the case of organometallic complexes, the metal-containing electrocatalyst support can be obtained simply by pyrolyzing the organometallic complex itself. An example of a representative organometallic complexes is cyclopentadienyl manganese tricarbonyl.

The following examples are provided for the purpose of illustration, not limitation.

### EXAMPLES

### Example 1

### Preparation of a Carbon Support for Platinum Comprising Manganese Metal Inclusions from the Pyrolysis of Manganese Acetate and 3,4,9,10-Perylenetetracarboxylic Dianhydride (PTCDA)

Step 1: Purification of PTCDA

PTCDA (Aldrich) was washed overnight with a 1:2 solution of de-ionized water (d.H₂O) and concentrated hydrochloric acid (HCl) under magnetic stirring to remove the metallic impurities present in the commercial product. The suspension was filtered, rinsed with d.H₂O, and air-dried at 75° C. The foregoing steps were repeated twice to obtain a total of three washings.

Step 2: Addition of Manganese Acetate to PTCDA

Manganese acetate hydrate ((C₂H₅O₂)₂Mn.4H₂O) was added in sufficient quantity to a suspension of PTCDA in d.H₂O to yield a Mn concentration in PTCDA of 1600 ppm (dry weight basis). The mixture of (C₂H₅O₂)₂Mn, PTCDA, and water was stirred vigorously stirred for 1 hour and then placed in an oven at 75° C. to evaporate the water. After the water had been evaporated, the cake composed of (C₂H₅O₂)₂Mn and PTCDA was ground into a fine powder.

Step 3: Pyrolysis of PTCDA Powders

An appropriate amount of the powder from step 2 was placed in a quartz boat and inserted into a quartz reactor tube. The tube was purged of air by flowing an argon-hydrogen mixture through it for 30 minutes. Next, the tube was heated inside a split oven furnace to a temperature of 400° C. and left at that temperature for one hour. Next, the temperature of the split oven was increased to 900° C. and maintained at that temperature for one hour. After cooling, the product was removed from the oven and ground into a very fine powder. The resulting product constituted the carbon electrocatalyst support comprising Mn metal inclusions upon which a platinum electrocatalyst was deposited according to step 4.

Step 4: Addition of Platinum to the Pyrolyzed Powders

About 3.4 g of NaHCO₃ was dissolved in 200 ml of d.H₂O. To this was added 0.6 g of the Mn-containing electrocatalyst support prepared by steps 1-3. The resulting mixture was refluxed overnight. While still under reflux, a solution composed of 1.0 g of H₂PtCl₆ dissolved in 60 ml d.H₂O was added dropwise to the suspension containing the Mn-containing electrocatalyst support. The resulting mixture was refluxed for an additional 2 hours and then 7.8 ml of a solution composed of d.H₂O and 780 μl of 37% formaldehyde in d.H₂O was added dropwise into the mixture. The suspension was refluxed overnight. The suspension was then filtered, washed with d.H₂O, dried in air at 75° C., and then ground to a fine powder. The product obtained at the end of this procedure contained about 40 wt % Pt on a carbon support containing Mn metal inclusions.

### Example 2

### Preparation of a Carbon Support for Platinum from the Pyrolysis of 3,4,9,10-Perylenetetracarboxylic Dianhydride (PTCDA)

In order to prepare an electrocatalyst wherein the carbon support does not contain Mn metal inclusions, the procedure set forth in Example 1 was followed except that no manganese acetate was added in step 2.

### Examples 3

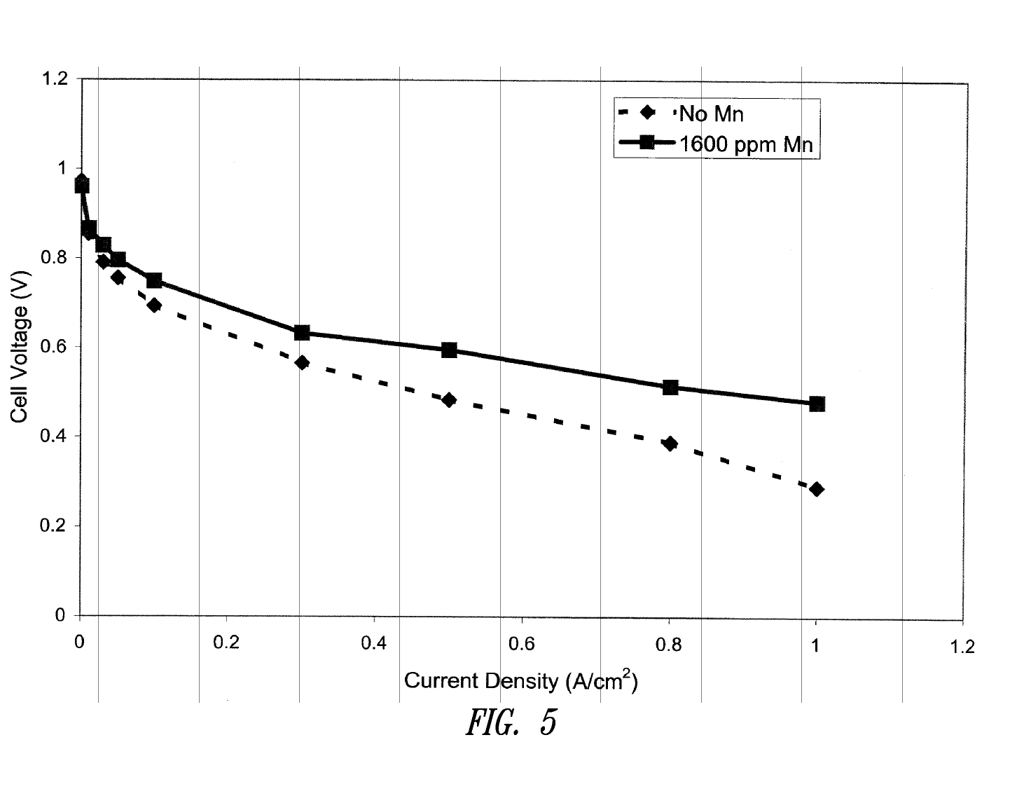

FIG. 5 shows the polarization curves of two fuel cells. The cathode electrocatalyst layer of the first fuel cell contains platinum supported on the Mn-containing carbon support material of Example 1, with 1600 ppm Mn in metallic form, while the cathode electrocatalyst layer of the second fuel cell contains platinum supported on a non-Mn-containing carbon support material. The anode and cathode Pt loadings of both fuel cells were 0.3 mg/cm² and 0.75 mg/cm², respectively. Each fuel cell was operated at 75° C. with fully humidified reactants (100% hydrogen as the fuel, and air as the oxidant). The fuel was supplied at 1.5 stoichiometry and the oxidant was supplied at 2.0 stoichiometry. FIG. 5 clearly shows that the fuel cell containing the Mn-containing carbon support material showed significantly better performance than the fuel cell that did not contain Mn in the carbon support material, thus confirming that the Mn-containing carbon support material is suitable for use in a fuel cell. Since the first fuel cell contains an Mn-containing carbon support material in the cathode electrocatalyst layer, it is expected that hydrogen peroxide and/or oxygen radical attack on the membrane should be hindered or prevented with long-term operation. It is also expected that precursors other than manganese acetate and PTCDA, such as those listed in U.S. Pat. No. 6,017,980, herein incorporated by reference, may also be employed into the electrocatalyst layer by the methods described in the foregoing.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

What is claimed is:

1. An electrocatalyst composition for use in an electrochemical fuel cell, the electrocatalyst composition comprising:
an electrocatalyst support comprising a carbon-containing species and at least one hydrogen peroxide and/or oxygen radical decomposition catalyst; and
a noble metal electrocatalyst supported on the electrocatalyst support,
wherein the at least one hydrogen peroxide and/or oxygen radical decomposition catalyst comprises transition metal inclusions within the electrocatalyst support, and wherein the electrocatalyst support does not comprise any nitrogen-containing species or metal oxides.

2. The electrocatalyst composition of claim 1 wherein the transition metal of the electrocatalyst support is not a Fenton's catalyst.

3. The electrocatalyst composition of claim 2 wherein the transition metal of the electrocatalyst support is selected from the group consisting of Mn and Zn.

4. The electrocatalyst composition of claim 3 wherein the transition metal of the electrocatalyst support is Mn.

5. The electrocatalyst composition of claim 1 wherein the noble metal electrocatalyst is platinum.

6. A membrane electrode assembly comprising:
an anode fluid diffusion layer;
a cathode fluid diffusion layer;
an ion-exchange membrane interposed between the anode and cathode fluid diffusion layers;
an anode electrocatalyst layer interposed between the ion-exchange membrane and the anode fluid diffusion layer; and
a cathode electrocatalyst layer interposed between the ion-exchange membrane and the fluid diffusion layer,
wherein at least one of the anode and cathode electrocatalyst layers comprises the electrocatalyst composition of claim 1.

7. The membrane electrode assembly of claim 6 wherein the cathode electrocatalyst layer comprises the electrocatalyst composition.

8. A electrochemical fuel cell comprising the membrane electrode assembly of claim 6.

9. A method of making an electrocatalyst composition for use in an electrochemical fuel cell, the method comprising:
pyrolyzing a carbon-containing species and a transition metal-containing species in the absence of any nitrogen-containing species to produce an electrocatalyst support which does not comprise any nitrogen-containing species or metal oxides; and
depositing a noble metal electrocatalyst on the electrocatalyst support.

10. The method of claim 9 wherein the transition-metal containing species is selected from the group consisting of Mn and Zn, and salts, oxides and organometallic complexes thereof.

11. The method of claim 9 wherein the noble metal electrocatalyst is platinum.
